(19) United States
(12) Patent Application Publication
(10) Pub. No.: US 2011/0020656 A1
(43) Pub. Date: Jan. 27, 2011

(54) Process for Functionalizing Hard Material Particles

(75) Inventors: Andreas Gier, Saarbrucken (DE); Ralf Sczepan, Essen (DE)

Correspondence Address: BACHMAN & LAPOINTE, P.C., 900 CHAPEL STREET, SUITE 1201, NEW HAVEN, CT, 06510, US

(73) Assignee: KRONOTEC AG, LUZERN (CH)

(21) Appl. No.: 12/747,622

(22) PCT Filed: Dec. 12, 2008
(86) PCT No.: PCT/EP2008/010581

§ 371 Date: Sep. 27, 2010

(30) Foreign Application Priority Data
Dec. 12, 2007 (DE) 10 2007 060 376.4

(51) Int. Cl. B32B 21/04; C08G 59/00

(52) U.S. Cl. 428/447; 528/405

(57) ABSTRACT

A process for functionalizing hard material includes reacting at least one anchor molecule with at least one hard material particle, where an anchor molecule has at least one silane bonding group and at least one polymerizable group. A functionalized hard material, in particular a-alumina, and surface coatings containing functionalized hard material, and a workpiece, in particular a wood material panel, an abrasive or a clutch disc, which is in each case provided with a surface coating containing functionalized hard material are described.

### BACKGROUND

Particles have great economic significance, in particular when they are used in surface coatings, which need to create abrasion-resistant surfaces for the most varying materials. As a rule, the particles are thereby mixed into polymerizable surface coatings, which, after curing, form a matrix made of synthetic resins on the surface to be coated. The surface coatings are usually adapted to the respective surface and to the application process.

Hard material particles include e.g. corundum, carbides, in particular silicon carbide and wolfram carbide, boron nitride, diamonds and silicates. Corundum is frequently referred to below. It is expressly noted that corundum is then also representative for other hard material particles.

Corundum is used for example on a large scale in the coating of wood and/or wood material surfaces, in particular in the coating of flooring elements with heat-curing, thermosetting synthetic resins. Corundum also contributes here to a significant degree to improving the abrasion resistance of the surface coating. It is known in this connection that the transparency of the coating is improved when silanized corundum is used. Corundum is silanized in order to adjust the polarity of the corundum surface better to the polarity of the respective synthetic resin so that the mixability of the corundum with the synthetic resin is improved. As a result, the transparency of the surface coating is then thereby improved.

However, besides thermosetting surface coatings for flooring elements, e.g. based on melamine resin, the lacquering of the surfaces is also gaining in significance. A thin layer of radiation-curing lacquers are applied to the surface of workpieces, here e.g. wood materials, in order to create abrasion-resistant coatings using hard material particles.

However, the permanent, secure inclusion of hard material particles in the lacquer of the surface coating is problematic. The abrasion resistance of the surface coating is highly impaired through the early breaking out of the hard material particles from the synthetic resin matrix. This phenomenon is independent of respectively selected synthetic resin, hard material or the type of surface to be coated.

### SUMMARY OF THE INVENTION

Thus, the object of the invention is to suggest polymerizable hard-material-particle-containing surface coatings, which have permanently high abrasion resistance.

This object is solved with a process for functionalizing hard material particles according to claim 1, with functionalized hard material particles according to claim 14, with coating materials, which contain functionalized hard material particles (claim 16) and with workpieces, in particular flooring panels, which are provided at least in sections with such surface coatings (claims 18, 19).

The process according to the invention for the production of functionalized hard material particles takes place through the reaction of at least one hard material particle with at least one anchor molecule, wherein an anchor molecule has at least one silane bonding group and at least one polymerizable group. Silane bonding group and polymerizable group are connected via a bridge group, which consists in the simplest case of one carbon atom.

### DETAILED DESCRIPTION OF THE PREFERRED EMBODIMENT(S)

In connection with this invention, the term anchor molecule is used for a molecule, which has at least one, preferably two or three silane bonding groups, which form a chemical bond with the surface of the hard material particle, and which has at least one polymerizable group, which preferably forms a cross-linking reaction with the polymerizable coating material of the surface coating. The hard material particle, typically corundum, is thereby permanently integrated into the matrix of the synthetic resin by means of chemical bonds and a breaking out of the particles from the cured surface coating as a result of use is largely prevented.

It results from the above that the polymerizable group behaves inertly under the reaction conditions, which lead to the adsorption of the silane bonding group to the surface of the hard material particle. The polymerizable group preferably reacts under the reaction conditions, e.g. heat or radiation, which lead to the curing of the polymerizable coating material of the surface coating.

According to the invention, an important error, which was shown during use of hard-material-containing surface coatings, is thus resolved. The efficiency of the used hard material in the abrasion behavior of the surface coating is considerably reduced in that the hard material particles (also silanized hard material particles) are not optimally integrated into the polymer matrix of a surface coating. They are broken out of the lacquer surface relatively quickly under the influence of abrasive wear. The solution according to the invention solves this problem. The functionalized hard material according to the invention is permanently integrated into the surface coating of a material, e.g. a wood material, of wood, abrasive medium or coupling disks, through the “integration” of selected polymerizable groups.

Corundum is a frequently used hard material. According to the invention, all other hard materials are also suitable, in particular the aforementioned carbides, nitrides, oxides and silicates and diamond. Hard materials with a density of more than 1.5 g/cm³, advantageously with a density of 1.75 g/cm³ to 4.5 g/cm³, are preferred.

In accordance with a preferred embodiment, the functionalization of hard material particles takes place in an inert solvent under the reaction conditions of hydrolysis. In this connection, inert means that the solvent under the conditions of the hydrolysis reacts neither with the silane bonding group nor with the polymerizable group. Water is not used as a solvent due to its strongly hydrolyzing properties. Inert, non-aqueous solvents are thus preferably used.

Typical inert solvents are alcohols, ester or ether solutions. Preferred solvents are aqueous, polymerizable monomers, which react with the coating material of the later surface coating. Mixtures of the aforementioned solvents can also be used. During selection of the polymerizable monomer(s) that can be used as solvent, it is preferred if the monomers have no reactive OH groups. The undesired condensation reactions between silane and solvent described above are thereby avoided. Preferred polymerizable monomers are among other things alkenes (e.g. butadiene), dicarbon acids and dicarbon acid derivates, diols, acrylic acid esters, acrylates, methacrylates, alkyl methacrylates, phthalic acid esters and/or diamines.

The integration of the silane bonding groups into the surface of the hard material particle takes place as a rule in the presence of slightly substoichiometric amounts of water, which enable a targeted reaction of the silane bonding groups with the hard material surface. The molar ratio between the hydrolyzable groups of the silane and water (expressed as the ROR value) should be set under 0.8, preferably under 0.6, advantageously under 0.4, especially preferably under 0.2.

A catalyst, which simplifies the hydrolysis of the silane bonding groups, is usually already added to the solvent. Typically, a base or an acid (organic or mineral) is used, for example hydrochloric acid, phosphoric acid, sulfuric acid, formic or acetic acid and sodium hydroxide, ammonia or ammonium hydroxide. Since diluted bases or acids are generally used, the water quantity added with the catalyst is used to set the desired ROR value.

As explained above, each anchor molecule requires at least one silane bonding group and at least one polymerizable group for the chemical cross-linking of the hard material particles with the polymer matrix of the surface coating. However, anchor molecules are preferably used, which have two, three or more silane bonding groups and two or more polymerizable groups. According to an advantageous embodiment of the invention, mixtures of different anchor molecules can also be used.

The polymerizable groups of the anchor molecule are preferably adapted for the polymerizable groups of the coating means and react with these groups so that a polymer matrix is created, into which the hard material particles are much better integrated than previously due to chemical bonds.

In order to realize the invention, one or more anchor molecules of the general formula

Rₐ(SiX)₄₋ₐ Formula 1

are generally suitable, wherein in Formula 1,
the remainders R are the same or different and represent non-hydrolyzable groups polymerizable under the reaction conditions of hydrolysis,
the remainders X on the silicon atom are the same or different and mean hydrolyzable groups or hydroxyl groups, generally silane bonding groups and
a has the value 1.2 or 3 or an oligomer derived from it. The value a is preferably 1.

In general Formula I, the hydrolyzable groups X (silane bonding groups), which can be the same or different from each other, are for example hydrogen or halogen (F, Cl, Br or I), alkoxy (preferably C₁₋₆ alkoxy, such as e.g. methoxy, ethoxy, n-propoxy and butoxy), aryloxy (preferably C6-10-aryloxy, such as e.g. phenoxy), acyloxy (preferably C2-7 acyloxy, such as e.g. acetoxy or propionoxy), alkylcarbonyl (preferably C2-7-alkylcarbonyl, such as e.g. acetyl), amino, monoalkyl amino or dialkyl amino with preferably 1 to 12, in particular 1 to 6, carbon atoms. Preferable hydrolyzable remainders are halogens, alkoxy groups and acyloxy groups. Especially preferable hydrolyzable groups are C1-4 alkoxy groups, in particular methoxy and ethoxy groups.

The polymerizable under the reaction conditions of hydrolysis, non-hydrolyzable remainders R, which can be the same or different, are non-hydrolyzable remainders R with a functional group, via which a cross-linking with the polymer matrix of a surface coating is possible. The remainders R are inert under the reaction conditions, under which the silane bonding groups attach to the surface of the hard material particles.

The non-hydrolyzable remainder R with a functional group, via which a cross-linking is possible, can e.g. be selected from a group, which as a functional group comprises an epoxide (e.g.: glycidyl or glycidyloxy), hydroxy, ether, amino, monoalkyl amino, dialkyl amino, if applicable substituted anilino, amide, carboxy, alkinyl, acryl, acryloxy, methacryl, methacryloxy, mercapto, cyano, alkoxy, isocyanato, aldehyde, alkylcarbonyl, acid anhydride and/or phosphoric acid, group. Preferred examples for the preferably polymerizable, non-hydrolyzable remainders R with functional groups, via which a cross-linking is possible, are a gycidyl or a glycidyloxy-(C1-20)-alkylene remainder, an acryloxy-(C1-6)-alkylene remainder, such as e.g. an acryloxymethyl, an acryloxyethyl or an acryloxypropyl remainder or a methacryloxy-(C1-6)-alkylene remainder, such as e.g. a metacryloxymethyl, a metacryloxyethyl or a methacryloxypropyl remainder. Especially preferred remainders are y-gylcidyloxypropyl and acryloxypropyl and methacryloxypropyl.

These functional groups are bonded to the silicon atom via alkyl, alkylene, alkenylene or arylene bridge groups, which can be broken by oxygen or NH groups. The bridge groups preferably contain 1 to 8 and in particular 1 to 6 carbon atoms. Examples for non-hydrolyzable remainders R with alkenyl or alkinyl groups are C2-6-alkenyl, such as e.g. vinyl, 1-propenyl, 2-propenyl and butenyl and C2-6-alkinyl such as e.g. acetylenyl and propargyl.

Concrete examples for corresponding anchor molecules are
y-glycidyloxypropyltrimethoxysilane,
y-glycidyloxypropyltriethoxysilane,
3-isocynattopropyltriethxysilane,
3-aminopropyltrimethoxysilane,
N-(2-aminoethyl)-3-aminopropyltrimethxysilane,
3-acryloxypropyltrimethoxysilane,
3-acryloxypropyltriethoxysilane,
3-methacryloxypropyltrimethoxysilane,
3-methacryloxypropyltriethoxysilane.

The “polymerizable” groups named in connection with the invention are in particular polymerizable, polyaddable and/or polycondensable groups. According to the invention, polymerization reactions are all reactions via which a cross-linking with the polymerizable coating material of the surface coating is possible. The polymerizable groups are preferably selected such that an organic cross-linking and integration of the hard material particles into the polymer matrix of the surface coating can be executed via if applicable catalyzed polymerization, addition and/or condensation reactions.

In order to perform the process described above, corundum is most frequently used as the main component among the generally known and available hard material particles. During the production of a dispersion, the solvent: hard material ratio is advantageously 1:1.5 to 1:3, preferably 1:2.0 to 1:2.5, respectively expressed in wt-%.

With respect to the hard material used, only a small portion of anchor molecules are required to better integrate the hard material particles into polymerizable coatings. With respect to the hard material used, only up to 0.001 wt-% of anchor molecules are used, preferably up to 0.01 wt-%, especially preferably up to 0.1 wt-%, advantageously up to 1.0 wt-% of the hard material. Thus, only a small amount of anchor molecules is required in order to enable a significant improvement in the adhesive strength or integration of the hard material into polymerizable coating materials or surface coatings respectively in that the bonding groups attach to the surface of the hard material. It should be considered a particular advantage of the invention that, as a result of the improved integration of hard material, usually from corundum into the polymer matrix of surface coatings, larger hard material particles can also be used. Larger hard material particles are much less expensive than highly reduced particles.

A stabilizer can be added in order to prevent the sedimentation of the functionalized hard material in the liquid medium, e.g. in a solvent made of liquid, polymerizable monomers, during transport and storage or also to prevent unwanted reactions of solvents and/or anchor molecules during transport and storage.

The object of the invention is the functionalized hard material as process product but the object of the invention are also polymerizable coating materials, which also have hard material particles in addition to polymerizable monomers and/or oligomers, which are connected with at least one anchor molecule, the at least one silane bonding group of which is connected with the surface of the hard material particle, and which have at least one polymerizable group, which polymerize with the monomers and/or oligomers of the coating material via addition or condensation. These can e.g. be both heat-curing as well as radiation-curing surface coatings.

The object of the invention is also a workpiece, in particular a wood material panel, which is at least in sections coated with a polymerized coating material, which contains hard material particles, in particular corundum, wherein the hard material particles are connected with an anchor molecule, which have at least one bonding group of a silane, which is chemically bonded with the surface of the hard material, and wherein the anchor molecule has at least one polymerized group, which is chemically bonded with the coating material via a preceding addition, condensation or polymerization reaction. Typical areas of application for surfaces coated according to the invention are workbenches, workstations or floors.

The object of the invention is also abrasive mediums and coupling disks, which are provided with a coating in the manner described above, which contains functionalized hard material particles according to the invention.

Details of the invention are described in greater detail based on the following exemplary embodiments:

### 1. Production of Functionalized Corundum

A dispersion of corundum is first produced in the solvent. For this, 60 wt-% corundum is stirred in using a dispersion agitator for 15 minutes in 40 wt-% 3,4 epoxycyclohexylmethyl-3-4-epoxycyclohexane. The 3,4-epoxycyclohexylmethyl-3-4-epoxycyclohexane serves as an inert solvent.

Then, 1 wt-% (with respect to the corundum used) of an anchor molecule, here y-gylcidyloxypropyltriethoxysilane, is added to this dispersion and also stirred for 15 minutes. The anchor molecule named above has three silane bonding groups and an epoxy group as a polymerizable group.

0.1 molar hydrochloric acid is then added in an amount that sets an ROR value of 0.8. After addition of the hydrochloric acid, the dispersion is stirred again for 30 minutes, whereby the temperature does not exceed 50° C.

The dispersion, containing functionalized corundum, can be stored for at least one month. Instead of corundum, other hard material particles can also be used, in particular those with a density of over 1.5 g/cm³ such as e.g. boron nitride, silicon carbide or diamonds.

### 2. Production of a Coating Material Containing Functionalized Corundum

The dispersion described above containing functionalized corundum is mixed with a liquid, UV-curing epoxide lacquer, e.g. Uvacure 1533 by Cytec, at weight ratio of 3:2. The weight ratio between epoxide lacquer and corundum dispersion can be selected in a broad range depending on how many corundum particles are required for the respective surface coating.

This surface material can be stored for at least one month.
3. Coating of a Workpiece with a Surface Coating Containing Functionalized Corundum

2% of a cationic photo starter (e.g. Additol PCPK by Cytec) is added to the coating material described above in order to ensure an even and fast curing of the epoxide lacquer. By means of roller application, 60 g/m² of this coating material is applied to MDF plates and then cured into an abrasion-resistant surface coating through the impact of UV light.

MDF plates coated according to the invention were subjected to an abrasion test. MDF plates coated with the same UV-curing epoxide lacquer, containing the same amount of corundum but only silanized and not functionalized, and cured under the same conditions as the MDF plates coated according to the invention, were used for comparison.

The abrasion test as per EN 13329 showed that all coated plates achieved abrasion class AC3. However, for the plates coated with functionalized corundum according to the invention, the test results were at least 15% better. Thus, either more overall abrasion-resistant surfaces or specified abrasion values with a smaller amount of corundum can be achieved.

1-16. (canceled)

17. Process for functionalizing corundum by reacting at least one anchor molecule with at least one corundum particle, wherein an anchor molecule has at least one silane bonding group and at least one polymerizable group and a bridge group with at least one carbon atom, the reaction of the at least one anchor molecule and the at least one corundum particle taking place in an inert, organic solvent under the reaction conditions of a hydrolysis, wherein the inert, organic solvent:corundum ratio is set in a range of 1:1.5 to 1:3.0, specified as wt-%, and with respect to the corundum used, up to 1.0 wt-% anchor molecules are used.

18. The process according to claim 17, comprising using at least one of alcohols, ethers and mixtures thereof as the inert, organic solvent.

19. The process according to claim 17, comprising using at least one of alkenes, dicarbon acids, diols, phthalic acid esters diamines, and mixtures thereof as the inert, organic solvent.

20. The process according to claim 17, comprising performing the reaction of the at least one anchor molecule and the at least one corundum particle in the presence of a catalyst selected from the group of an acid or a base.

21. The process according to claim 20, comprising selecting the catalyst from a group consisting of sodium hydroxide, ammonia, ammonium hydroxide, mineral acid hydrochloric acid, sulfuric acid, phosphoric acid and organic acids.

22. The process according to claim 17, comprising using at least one silane with the general formula Rₐ(SiX)-4-a, wherein the remainders R are the same or different and represent non-hydrolyzable, polymerizable groups under the reaction conditions of hydrolysis, the remainders X are the same or different and mean hydrolyzable groups or hydroxy groups and a has the value 1.2 or 3, or a oligomer derived from it.

23. The process according to claim 22, comprising using at least one hydrolyzable group selected from hydrogen, a halogen, an alkoxy, aryloxy, acyloxy, alkylcarbonyl, amino, monoalkyl amino, dialkyl amino with 1 to 12 carbon atoms and mixtures thereof.

24. The process according to claim 23, wherein said using step comprises using a halogen selected from the group of F, Cl, Br or I).

25. The process according to claim 23, wherein said using step comprises using an alkoxy selected from the group of C₁₋₆ alkoxy, methoxy, ethoxy, n-propoxy and butoxy.

26. The process according to claim 23, wherein said using step comprises using an aryloxy selected from the group of C6-10-aryloxy and phenoxy.

27. The process according to claim 23, wherein said using step comprises using an acyloxy selected from the group C2-7 acyloxy, acetoxy and propionoxy.

28. The process according to claim 23, wherein said using step comprises using an alkylcarbonyl selected from the group of C2-7 alkylcarbonyl and acetyl.

29. The process according to claim 23, wherein said using step comprises using one of an amino, monoalkyl amino and a dialkyl amino with 1 to 6, carbon atoms.

30. The process according to claim 22, comprising selecting the remainder(s) R from a group consisting of an epoxide, a glycidyl epoxide, a glycidyloxy epoxide, a hydroxy, ether, amino, monoalkyl amino, dialkyl amino, substituted anilino, amide, carboxy, alkenyl, alkinyl, acryl, acryloxy, methacryl, methacryloxy, mercapto, cyano, alkoxy, isocyanato, aldehyde, alkylcarbonyl, acid anhydride, phosphoric acid groups and mixtures thereof.

31. The process according to claim 22, comprising bonding as bridge group an alkyl, an alkylene, an alkenylene or an arylene groups, which can be broken by oxygen or NH groups, to the silicon atom.

32. The process according to claim 31, wherein the bonding step comprises using a bridge group having 1 to 8 carbon atoms.

33. The process according to claim 31, wherein the bonding step comprises using a bridge group having 1 to 6 carbon atoms.

34. The process according to claim 17, comprising setting the inert solvent:corundum ratio in a range from 1:2.0 to 1:2.5, specified as wt-%.

35. The process according to claim 17, comprising with respect to the corundum used, using up to 0.001 wt-% anchor molecules, preferably up to 0.01 wt-%, especially preferably up to 0.1 wt-%, anchor molecules.

36. The process according to claim 17, comprising, with respect to the corundum used, using up to 0.01 wt-% anchor molecules.

37. The process according to claim 17, comprising with respect to the corundum used, using up to 0.1 wt-% anchor molecules.

38. Corundum, bonded to an anchor molecule, having at least one bonding group of a silane of which is chemically bonded with the surface of the corundum, wherein the anchor molecule has at least one polymerizable group, which is polymerizable via addition or condensation with a polymerizable coating material, into which the corundum is to be mixed, the corundum, with respect to the corundum used, having up to 0.1 wt-% anchor molecules.

39. Coating material with polymerizable mono and/or oligomers and corundum, wherein the corundum is connected with an anchor molecule, at least one bonding group of a silane of which is chemically bonded with the surface of the corundum, and that has at least one polymerizable group, which is polymerizable via addition or condensation with the polymerizable mono and/or oligomers, and the corundum, with respect to the corundum used, having up to 0.1 wt-% anchor molecules.

40. Coating material according to claim 39, wherein said coating material is radiation-curable or heat-curable.

41. Workpiece, which is coated at least in sections with a polymerized coating material, which contains corundum, wherein the corundum is connected with an anchor molecule, which has at least one bonding group of a silane, which is chemically bonded with the surface of the corundum, and wherein the anchor molecule has at least one connection, which is established through one of addition, condensation and polymerization with the polymerized coating material, wherein the corundum, with respect to the corundum used, has up to 0.1 wt-% anchor molecules.

42. Wood material panel, which is coated at least in sections with a polymerized coating material, which contains corundum, wherein the corundum is connected with an anchor molecule, which has at least one bonding group of a silane, which is chemically bonded with the surface of the corundum, and wherein the anchor molecule has at least one connection, which is established through one of addition, condensation and polymerization with the polymerized coating material, and wherein the corundum, with respect to the corundum used, has up to 0.1 wt-% anchor molecules.
